(19) United States
(12) Patent Application Publication
(10) Pub. No.: US 2012/0283027 A1
(43) Pub. Date: Nov. 8, 2012

(54) Central Lubrication of Articulated Shafts

(75) Inventors: Uwe Bürling, Hennef (DE); Bernd Carstensen, Ruppichteroth (DE)

(73) Assignee: GKN Walterscheid GmbH, Lohmar (DE)

(21) Appl. No.: 13/462,858

(22) Filed: May 3, 2012

(30) Foreign Application Priority Data
May 6, 2011 (DE) 102011050166.5

(51) Int. Cl. F16C 3/03; F16N 1/00

(52) U.S. Cl. 464/7

(57) ABSTRACT

A central lubrication system for lubricating a telescopic shaft (1, 101, 201) has a lubrication device (10, 110, 210) and an inner profiled tube (2, 102, 202) of the telescopic shaft (1, 101, 201). The lubrication device (10, 110, 210) is insertable into the inner profiled tube. At least one feed duct (11, 111, 211) feeds lubricant to the portions of the telescopic shaft (1, 101, 201) to be lubricated.

### CROSS-REFERENCE TO RELATED APPLICATION

This application claims priority to German Patent Application No. 102011050166.5, filed May 6, 2011. The entire disclosure of the above application is incorporated herein by reference.

### FIELD

The disclosure relates to central lubrication system for lubricating a telescopic shaft. A lubrication device is insertable into an inner profiled tube of the telescopic shaft. The lubrication device has at least one feed duct to feed lubricant to the to be lubricated portions of the telescopic shaft. The lubrication device has a filling element, a discharge element and a first lubricant duct. The filling element feeds lubricant to the lubrication device. The discharge element distributes lubricant to the to be lubricated portions of the telescopic shaft. The first lubricant duct is positioned between the filling element and the discharge element.

### BACKGROUND

A central lubrication device for a telescopic shaft is shown in DE 42 37 176 C1. Here, the lubrication device has two formed pieces with respective connection pieces. The first formed piece is held via two end-sided conical pieces sealingly in diametrically opposite through openings of the inner sliding profile. The second formed piece is inserted into the inner sliding profile in the area of the joint yoke. The second formed piece is provided on the outside with a lubrication nipple. Via the respective connection piece, the two formed pieces are connected to a hose that transmits lubricant.

DE 601 20 815 T2 shows a grease lubrication system within an inner hollow shaft of a telescopic shaft with two axially distanced blocks, between which two parallel tubes extend. The first block is provided with a lubrication nipple. The second block is held, via two hollow pins, in position. Thus, the pins rest in the second block and engage in two diametrically opposite holes in the wall of the inner hollow shaft Via the hollow pins, lubricant can move radially outward.

DE 199 62 212 A1 discloses a lubrication device for telescopic shafts with tube portions displaceably relative to each other. In an inner tube portion a grease muff is arranged for filling-in grease. Furthermore, for the delivery of grease, a grease distribution element is provided in the inner tube portion and connected to it. The grease muff and the grease distribution element are connected to each other via a small connection tube. The distribution element has two portions. One of the portions is accommodated in the inner tube and has a central through passage for the grease. The other portion of the distribution element is displaceably arranged with reduced play in the inner profile of an outer tube portion of the telescopic shaft. The other portion has a radial through passage that is connected to the central passage and distributes grease to the two telescopic tube portions.

U.S. Pat. No. 1,973,702 shows a central lubrication device for lubricating a telescopic shaft. The lubrication device, itself, is formed in an inner shaft of the telescopic shaft. It has feed ducts to feed lubricant to portions of the telescopic shaft to be lubricated. In an outer shaft of the telescopic shaft, a removable plug is provided. Grease passes through the outer shaft, with the plug removed, to fill the inner chamber of the telescopic shaft. The feed ducts of the inner tube communicate with the inner chamber of the outer tube. Radially extending lubricant distribution ducts pass lubricant to the to be lubricated portions of the sliding arrangement.

### SUMMARY

Starting from this, an object of the present disclosure is to provide a central lubrication system with a lubrication device that is insertable into a telescopic shaft in a simple manner.

The object is solved by a central lubrication system for lubricating a telescopic shaft, comprising a lubrication device and an inner profiled tube of the telescopic shaft. The lubrication device is insertable into the inner profiled tube. The lubrication device includes at least one feed duct to feed lubricant to the to be lubricated portions of the telescopic shaft. The lubrication device has a filling element to feed lubricant to the lubrication device. A discharge element distributes lubricant to the to be lubricated portions of the telescopic shaft. A first lubricant duct is positioned between the filling element and the discharge element. The discharge element has a circumferentially extending outer groove. The outer groove together with the inner profiled tube forms a circumferentially extending distribution duct. The circumferential duct communicates with the first lubricant duct as well as the feed duct.

An advantage in this embodiment is that since because of the circumferentially extending distribution duct formed by the circumferentially extending outer groove and the inner profiled tube, the feed duct can be provided in the inner profiled tube at any position on the circumference of the inner profiled tube as long as it is arranged in the cross-sectional plane of the outer groove. A circumferential alignment or an alignment in a radial direction of the discharge element and the inner profiled tube or its feed duct to each other has not been achieved in view of the exit of the lubricant from the discharge element and the passage through the inner profiled tube. The lubricating grease can exit via the complete circumference in the area of the outer groove of the discharge element or can enter the feed duct of the inner profiled tube. Only a circumferential alignment or an alignment in radial direction of the discharge element and of the inner profiled tube in view of the profile of the inner and the outer profiled tube to each other has to be achieved. The discharge element also has this profile. However, in the circumferential portion, the feed duct is arranged in the inner profiled tube and can be freely determined. Several feed ducts can be provided across the circumference of the inner profiled tube, which circumferential position can again be freely selected. Two feed ducts are arranged at least approximately diametrically opposite to each other.

By communication of the circumferentially extending distribution duct with the first lubricant duct as well as the feed duct, an exchange or a fluid connection between these ducts exists.

The circumferentially extending outer groove is axially aligned to the feed duct. Here, this ensures that the radial plane, where the circumferentially extending outer groove is arranged on the discharge duct, and the radial plane, where the feed duct is arranged on the inner profiled tube, do approximately coincide.

As a whole, this embodiment enables the distribution of lubricant to the to be lubricated portions of the telescopic shaft. This is achieved by lubricant passing from the circumferentially extending outer groove, via the feed duct, to the overlapping portion between the inner and the outer profiled tube. This overlapping portion, also designated as the covering portion, can thus be greased or lubricated when the telescopic shaft is in the assembled condition, inserted into each other, without the inner and the outer profiled tube being pulled out of each other.

The filling element is formed as a lubrication nipple that is preferably accommodated in the inner profiled tube. The lubrication nipple can be screwed into, pressed into or driven into the profiled tube. Thus, an inexpensive standard component readily available can be used as the lubrication nipple. Additionally or alternatively, the filling element can also be accommodated in a grooved fork that is held at an axial end on the inner profiled tube by a securing pin.

A filling arrangement comprises the filling element, preferably in the form of a lubrication nipple, and a receptacle. The receptacle advantageously serves to provide a suitable connection between the filling element and the first lubricant duct. The receptacle ensures a directional change between the filling element and the first lubricant duct. The filling element is preferably a lubrication nipple in a radial direction in the inner profiled tube. The first lubricant duct extends parallel to a longitudinal direction of the telescopic shaft in the inner profiled tube.

The receptacle has a circumferentially extending outer groove. The outer groove, together with the inner profiled tube, forms a circumferentially extending accommodation duct. The accommodation duct communicates with the first lubricant duct as well as the filling element. Initially, the receptacle and the discharge element are formed essentially identically so that manufacturing is simplified. Furthermore, the advantages described above concerning the discharge element apply.

The receptacle is sealed at both axial sides of the circumferentially extending outer groove to the inner face of the inner profiled tube. This ensures that the receptacle, formed by the circumferentially extending outer groove and the inner profiled tube, is sealed and that no lubricant can accidentally exit. Sealing rings can be provided at both sides of the circumferentially extending outer groove. Alternatively, sealing can be achieved by a specific integral forming of the receptacle onto the inner face of the inner profiled tube.

The filling element engages the circumferentially extending outer groove of the receptacle. The filling element axially retains the receptacle relative to the inner profiled tube. Thus, with a simple means, an axial retaining of the complete lubricant device relative to the inner profiled tube is achieved. The engagement of the filling element in the circumferentially extending outer groove does not demand specific requirements concerning the dimensional permanence. Generally, a small engagement depth of the inner end of the filling element in the circumferentially extending outer groove is sufficient. Also, a small engagement width of the inner end of the filling element relative to the width of the circumferentially extending outer groove can generally be sufficient. A certain axial wandering of the receptacle in the inner profiled tube is harmless.

A bore extends through the receptacle to transmit lubricant and to connect the filling element to the first lubricant duct. Preferably, this bore extends from the base of the circumferentially extending outer groove to the axial end of the receptacle that is facing the discharge element. Thus, the receptacle can transmit the lubricant from the filling element, in form of the lubrication nipple, to the first lubricant duct. Furthermore, the bore is, with respect to manufacturing, simple to provide.

The discharge element is sealed at both axial sides of the circumferentially extending outer groove relative to the inner face of the inner profiled tube. Advantages described concerning the sealing of the receptacle at both axial sides of the circumferentially extending outer groove apply. Sealing rings or alternatively a forming-on of the discharge element onto the inner face of the inner profiled tube can be used.

A bore extends through the discharge element to transmit lubricant and connect the first lubricant duct to the feed duct. Preferably, the bore extends from the base of the circumferentially extending outer groove to the axial end of the discharge element that faces the filling element or the first lubricant duct. Advantageously, the generally identical structure of the discharge element and the receptacle achieve the same advantages.

A second lubricant duct is provided to distribute lubricant to additional portions of the telescopic shaft and connect the discharge element to the additional portions, to be lubricated. Thus, in an advantageous manner, the central lubrication system can be extended in a modular manner.

A bore extends from the circumferentially extending outer groove to both axial ends of the discharge element. The bore is arranged in the discharge element to transmit lubricant and connect the first lubricant duct to the feed duct and to the second lubricant duct. Preferably, the bore extends from the base of the circumferentially extending outer groove, T-like, to the axial ends of the discharge element.

Additionally, the to be lubricated portions are arranged on a universal joint, especially between the cross and a fork with a groove, which is connected to an outer profiled tube. Thus, in an advantageous manner, a universal joint, generally existing and which has commonly its own lubrication nipple for lubricating, can be connected to the central lubrication system.

The second lubricant duct is length adjustable and is spiral-like or elastic formed. Thus, the central lubrication or the lubricant device adapts itself to a change in the length of the telescopic shaft during operation.

The discharge element is axially locked, via a clamping sleeve, relative to the inner profiled tube. The clamping sleeve rests in the feed duct of the inner profiled tube. The clamping sleeve engages the circumferentially extending groove of the discharge element. Thus, in an advantageous manner, a further or additional locking of the lubricant device can be achieved relative to the inner profiled tube. Alternatively, the clamping sleeve can also radially inwardly engage in the bore of the discharge element which serves to transmit lubricant.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1a is a longitudinal sectional view through a first embodiment of the central lubrication system;

FIG. 1b is a cross-sectional view along line B-B of FIG. 1a;

FIG. 2 is a second embodiment of the central lubrication system;

FIG. 3 is a longitudinal sectional view through a third embodiment of the central lubrication system; and

FIG. 4 is a longitudinal sectional view of a variant of the first embodiment of the central lubrication system.

### DETAILED DESCRIPTION

Example embodiments will now be described more fully with reference to the accompanying drawings.

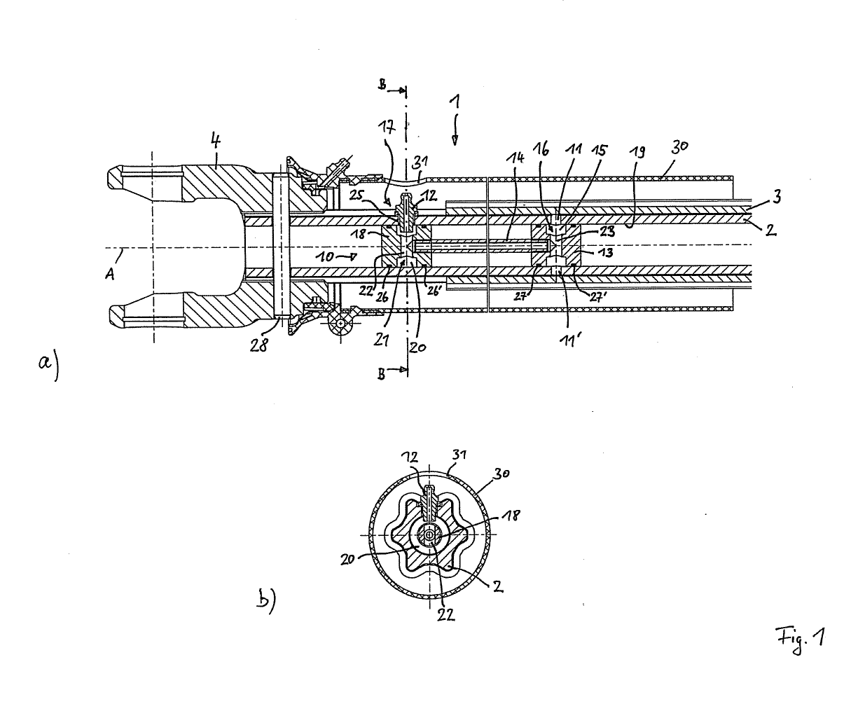

FIGS. 1 to 4 are initially described together concerning their corresponding features of the embodiments. In this case, the first embodiment has reference numerals up to the numeral 99. The second embodiment has reference numerals up to the numeral 199. The third embodiment has reference numerals up to the numeral 299.

An articulated shaft is shown that serves to drive an agricultural implement by means of a power take-off shaft of a tractor. Both ends of the shaft include mounted universal joints. One has a non shown grooved fork for the connection to the power take-off shaft. The other has a non shown grooved fork for the connection to the drive shaft of an agricultural implement. The inner grooved forks 4, 4′ are respectively held by a clamping sleeve 28, 28′ on the respective profiled tube.

The articulated shaft is formed as a telescopic shaft 1, 101, 201 with an outer profiled tube 3, 103, 203 and an inner profiled tube 2, 102, 202. The profiled tubes 2, 102, 202, 3, 103, 203 are rotationally fast connected and are length adjustable to each other. Thus, a torque can be transmitted between them and the total length of the telescopic shaft 1, 101, 201 can be varied. The two profiled tubes 2, 102, 202, 3, 103, 203 have a cross-section deviating from a circular shape. Thus, via these, a form fitting engagement of both profiled tubes 2, 102, 202, 3, 103, 203 within each other for the transmission of a torque is ensured, as it is visible in FIG. 1b. The rotating telescopic shaft 1, 101, 201 includes an outer protection tube 30, 130, 230 and a not shown inner protection tube. Both are telescopically inserted into each other for length adjustment. Each protection tube is mounted in the area of the connection flange of the respective universal joint on the outer or the inner profiled tube 2, 102, 202, 3, 103, 203.

The lubrication device 10, 110, 210 is pushed or inserted into the inner profiled tube 2, 102, 202 along the longitudinal axis A. The lubrication device 10, 110, 210 has a filling arrangement 17, 117, 217 and a receptacle 18, 118, 218, a discharge element 13, 113, 213 and a first lubricant duct 14, 114, 214. The filling element is in the form of a lubrication nipple 12, 112, 212. The first lubricant duct 14, 114, 214 connects the filling arrangement 17, 117, 217 and the discharge element 13, 113, 213 to each other. Via the lubricant duct 14, 114, 214, lubricant can be delivered between the filling arrangement 17, 117, 217 and the discharge element 13, 113, 213. The first lubricant duct 14, 114, 214 represents a fast connection between the filling arrangement 17, 117, 217 and the discharge element 13, 113, 213 in the sense that, via the first lubricant duct 14, 114, 214, tension- and compression forces can be transmitted between the filling arrangement 17, 117, 217 and the discharge element 13, 113, 213.

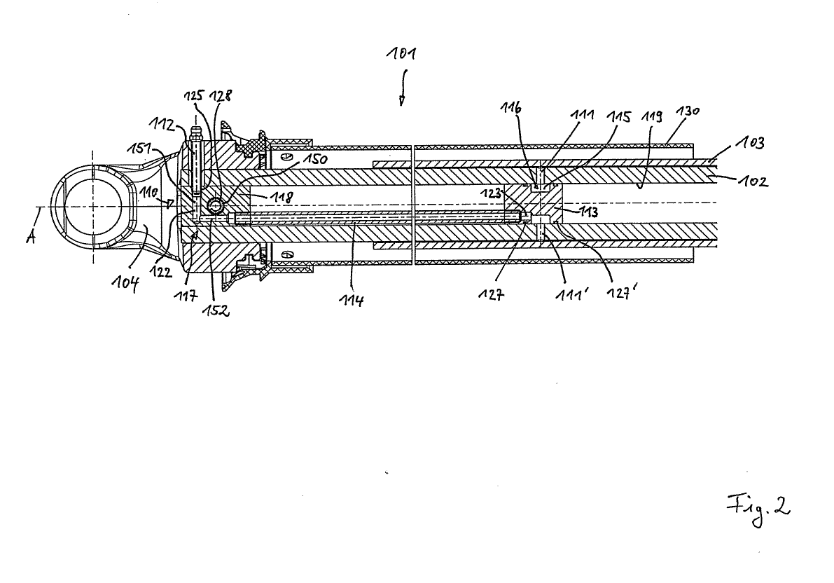

The outer contours of the receptacle 18, 118, 218 and the discharge element 13, 113, 213 are adapted to the inner contour of the inner profiled tube 2, 102, 202, insofar as they can also be characterised as a piston, as it is visible from FIG. 1b. The outer contour of the two elements 18, 118, 218, 13, 113, 213 corresponds to the form-fitting profiling between the outer profiled tube 3, 103, 203 and the inner profiled tube 2, 102, 202. The lubrication device 10, 110, 210 is held, via the filling element in the form of the lubrication nipple 12, 112, 212, in the inner profiled tube 2, 102, 202. The lubrication nipple 12, 112, 212 is held and radially aligned by a screw connection 25, 125, 225 in the inner profiled tube 2, 102, 202. The outer protection tube 30, 130, 230 has a radially outside access opening 31, 131, 231 towards the lubrication nipple 12, 112, 212. Alternatively, the lubrication nipple 12, 112, 212 can also be pressed in the inner profiled tube 2, 102, 202. The lubrication nipple 12, 112, 212 form-fittingly engages, via its radially inwards inner end, the receptacle 18, 118, 218. Alternatively, in the embodiment according to FIG. 2, the lubrication nipple 112 is held with one of the above described connections in the grooved fork 104.

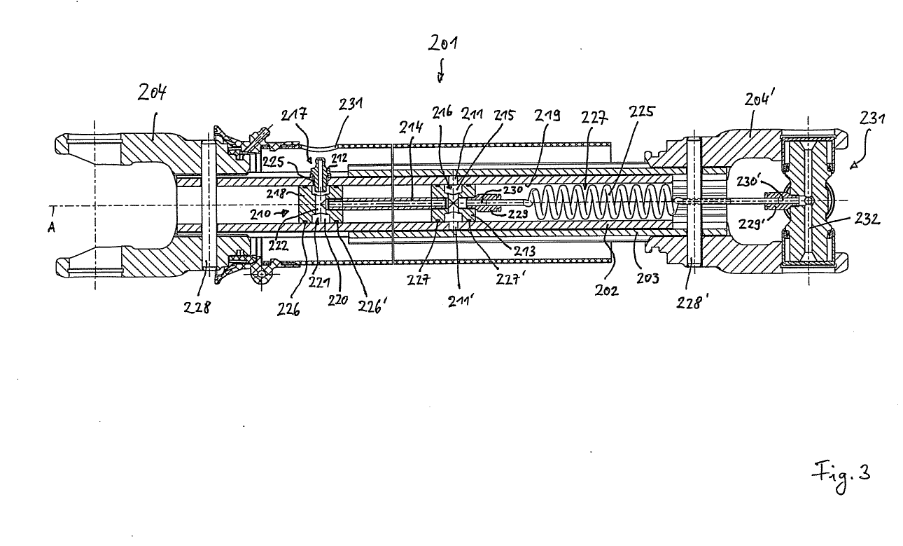

In the embodiments according to FIGS. 1 and 3, the receptacle 18, 118, 218 and the discharge element 13, 113, 213 are symmetrically formed, as far as possible, relative to a vertical plane of symmetry. The existing differences are described in the following. The receptacle 18, 218 has a circumferentially extending outer groove 20, 220. The outer groove 20, 220 together with the inner face 19, 219 of the inner profiled tube 2, 202 forms a circumferentially extending accommodation duct 21, 221. The lubrication nipple 12, 212 radially engages, in a form-fitting manner, in the inside of the circumferentially extending outer groove 20, 220. The discharge element 13, 213 has a circumferentially extending outer groove 15, 215. The outer groove 15, 215 together with the inner face 19, 219 of the inner profiled tube 2, 202 forms a circumferential distribution duct 16, 216. The inner profiled tube 2, 202, in the area of the distribution duct 16, 216, has two feed ducts 11, 11′, 211, 211′. The feed ducts 11, 11′, 211, 211′ enable the lubricant to pass from the distribution duct 16, 216 to the to be lubricated areas between the inner and the outer profiled tube 2, 202, 3, 203. The feed ducts 11, 11′, 211, 211′ can be formed as radially directed bores arranged diametrically opposite to one another. Alternatively, the direction of the bores can also extend differently. Also, only one bore or more than two bores can be provided along the circumference of the profiled tube 2, 202.

The receptacle 18, 218 and the discharge element 13, 213 can, when seen in longitudinal sectional view, be characterised as a dumbbell-shaped because of the respective circumferentially extending outer groove 15, 215, 20, 220. At both axial sides of the circumferentially extending outer groove 15, 215, 20, 220, the receptacle 18, 218 and the discharge element 13, 213 are sealed relative to the inner face 19, 219 of the inner profiled tube 2, 202, so that a piston-cylinder-arrangement is achieved. For sealing, sealing rings 26, 26′, 27, 27′, 226, 226′, 227, 227′ are provided. Alternatively, sealing can also be achieved by means of a forming-on of the receptacle 18, 218 and of the discharge element 13, 213 onto the inner face 19, 219 of the inner profiled tube 2, 202. Preferably, in each embodiment, the receptacle 18, 218 and the discharge element 13, 213 are made from a synthetic material.

In the receptacle 18, 218 and in the discharge element 13, 213, a bore 22, 222, 23, 223 extends respectively, for transmitting lubricant. The bores 22, 222, 23, 223 extend respectively from opposite sides, i.e. diametrically, of the bottom of the circumferentially extending outer grooves 15, 215, 20, 220 to the axial ends of the elements 18, 218, 13, 213, which are facing each other or at which the first lubricant duct 14, 214 for connecting the two elements 18, 218, 13, 213 starts. FIG. 1 shows a first variant of the attachment where the first lubricant duct 13 is pressed into the respective bore 22, 23 of the receptacle 18 and of the discharge element 13. Alternatively, the first lubricant duct 14 can be pressed into the elements 18, 13 also by means of a separate connection element with a through bore, as it is described for the second lubricant duct 227 of FIG. 3. The described variants of the attachment of the first lubricant duct 14, 214 on the receptacle 18, 218 and on the discharge element 13, 213 can be used in each of the embodiments.

In the embodiment shown in FIG. 3, the bore 223 extends in the discharge element 213 from opposite sides, i.e. diametrically, of the bottom of the circumferentially extending outer groove 215 to the two axial ends of the discharge element 213. Thus, the bore 223 has a cross-like extension within the discharge element 213. At the axial end, which is facing away from the first lubricant duct 214, a second lubricant duct 227 is pressed-in by means of a connection element 229 with an axial through bore 230. Alternatively, the first variant of the attachment described above can be provided without a separate connection element 229. The other axial end of the second lubricant duct 227 is pressed into the cross 231 at the to be lubricated universal joint 204′. A connection element 229′ with a through bore 230′ is pressed into the cross centrally in the longitudinal axis A of the telescopic shaft 201. Here, an eccentrically connection can alternatively be provided. In the cross 231, a cross-like extending bore 232 is provided to feed lubricant radially outward to the to be lubricated portions.

The second lubricant duct 227 is length adjustably formed. In this embodiment, length adjustment of the telescopic shaft 201 changes the axial distance between the universal joint 204 and the inner profiled tube 202, which includes the lubrication device 210. Thus, a length adaption of the lubricant device 210 can be achieved. The second lubricant duct 227 is formed spiral-like in an area 227 for the length adjustment. Alternatively, it also can be formed elastically in whole or in portions.

The embodiment of FIG. 2 is described in the following concerning its differences to the beforehand described embodiments. The embodiment of FIG. 2 has a receptacle 118 that sits serving as a type of closure plug, in the axial end of the inner profiled tube 102. The grooved fork 104 of the tractor-sided universal joint, still not shown, is held axially non-displaceably by means of the clamping sleeve 128 on the axial end of the inner profiled tube 102. The grooved fork 104 is non-rotationally held, via the shape of the inner profiled tube 102. The receptacle 118 has a centrally and radially extending through bore 150 for the passage of the clamping sleeve 128.

A bore 122 for the passage of lubricant extends in the receptacle 118. The bore 122 extends from an outer circumference of the receptacle 118 to the axial end of the receptacle 118. The axial end faces the inside of the inner profiled tube 102. The bore 122 extends with a radial portion 151 and an axial portion 152 in relation to the longitudinal axis A of the telescopic shaft 101. The axial portion 152 extends parallel off-set to the longitudinal axis A. Thus, the axial portion 152 extends collision-free and laterally off-set to the through bore 150 and to the clamping sleeve 128 passing through it. The axial portion 152 of the bore 122 ends at the axial end of the receptacle 118, on which, as described above, the first lubricant duct 114 starts.

In FIG. 2 the variant of the connection is shown. The first second lubricant duct 114 is pressed into the receptacle 118 and the discharge element 113. The variant with a separate connection element can also be provided here. Because of the above described off-set of the axial portion 152 of the bore 122 to the longitudinal axis A, the first lubricant duct 114 also extends off-set. Preferably, it is parallel to the longitudinal axis A. The bore 123 of the discharge element 113 extends from opposite sides, i.e. diametrically, of the bottom of the circumferentially extending outer groove 115 to the axial end of the discharge element 113. The bore 123 ends axially off-set to the longitudinal axis A. By the way, the shape of the discharge element 113 of the distribution duct 116 and of the supply ducts 111, 111′ of the outer profiled tube 102 correspond to the above described embodiments.

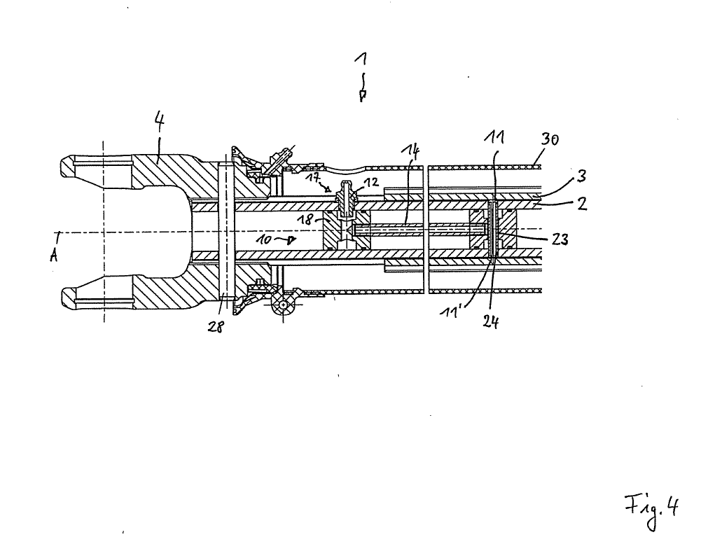

FIG. 4 shows a variant of the first embodiment. Here, a clamping sleeve 24 is provided for the axial fixing of the lubrication device 10 relative to the inner profiled tube 2. The clamping sleeve 24 sits in the feeding duct 11, 11′ and in the bore 23 of the discharge element 13. This variant can also be used in the other embodiments.

The lubrication device 10 extends through the greater part of the inner profiled tube 2, 102, 202. This way it is ensured, that a retracting of the telescopic shaft 1 is not prevented by the radially projecting lubrication nipple 12, 112, 212. In a completely extended telescopic shaft 1, 101, 201, the discharge element 13, 113, 213 and the feed ducts 11, 11′, 111, 111′, 211, 211′ are still arranged in an area, in which the outer and the inner profiled tube 2, 102, 202, 3, 103, 203 overlap each other to feed lubricant to this area.

In all embodiments, the lubrication device 10, 110, 210 is accommodated in the inner profiled tube 2, 102, 202. Also, it is integrated into the telescopic shaft 1, 101, 202 in such a way that the advantages of the central lubrication system can be achieved.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A central lubrication system for lubricating a telescopic shaft comprising:
a lubrication device;
an inner profiled tube of the telescopic shaft;
the lubrication device is insertable into the inner profile tube, the lubricating device has at least one feed duct to feed lubricant to the to be lubricated portions of the telescopic shaft;
the lubrication device includes:
a filling element to feed lubricant to the lubrication device;
a discharge element to distribute lubricant to the to be lubricated portions of the telescopic shaft; and
a first lubricant duct between the filling element and the discharge element; and
the discharge element has a circumferentially extending outer groove, the outer groove together with the inner profiled tube forms a circumferentially extending distribution duct that communicates with the first lubricant duct as well as with the feed duct.

2. The central lubrication system according to claim 1, wherein the circumferentially extending outer groove is aligned concerning the feed duct.

3. The central lubrication system according to claim 1, wherein the filling element is a lubrication nipple that is accommodated in the inner profiled tube.

4. The central lubrication system according to claim 1, further comprising a filling arrangement including the filling element and a receptacle.

5. The central lubrication system according to claim 4, wherein the receptacle has a circumferentially extending outer groove, the outer groove together with the inner profiled tube forms a circumferentially extending accommodation duct that communicates with the first lubricant duct as well as the filling element.

6. The central lubrication according to claim 5, wherein the receptacle is sealed at both axial sides of the circumferentially extending outer groove to the inner face of the inner profiled tube.

7. The central lubrication system according to claim 5, wherein the filling element engages in the circumferentially extending outer groove of the receptacle to axially retain the receptacle relative to the inner profiled tube.

8. The central lubrication system according to claim 4, wherein a bore extends in the receptacle to transmit a lubricant and connect the filling element to the first lubricant duct.

9. The central lubrication system according to claim 1, wherein the discharge element is sealed at both axial sides of the circumferentially extending outer groove relative to the inner face of the inner profiled tube.

10. The central lubrication system according to claim 1, wherein a bore extends in the discharge element to transmit lubricant and connect the first lubricant duct to the feed duct.

11. The central lubrication system according to claim 1, further comprising a second lubricant duct for distributing lubricant to additional portions of the telescopic shaft, to be lubricated, and connect the discharge element to the additional portions to be lubricated.

12. The central lubrication system according to claim 11, wherein a bore extends from the circumferentially extending outer groove to both axial ends of the discharge element, the bore to transmit lubricant is arranged in the discharge element and connects the first lubricant duct to the feed duct and to the second lubricant duct.

13. The central lubrication system according to claim 11, wherein the additional portions, to be lubricated, is arranged on a universal joint that is connected to an outer profiled tube.

14. The central lubrication system according to claim 11, wherein the second lubricant duct is length adjustable.

15. The central lubrication system according to claim 1, wherein the discharge element is axially locked via a clamping sleeve relative to the inner profiled tube, the clamping sleeve rests in the feed duct of the inner profiled tube and engages the circumferentially extending groove of the discharge element.
